(19) United States
(12) Patent Application Publication
(10) Pub. No.: US 2026/0016225 A1
(43) Pub. Date: Jan. 15, 2026

(54) APPARATUS AND METHOD FOR MANUFACTURING ELECTRODE PLATE OF SECONDARY BATTERY INCLUDING DRYING UNIT

(71) Applicant: SAMSUNG SDI CO., LTD., Yongin-si (KR)

(72) Inventor: Nahui KIM, Yongin-si (KR)

(21) Appl. No.: 19/186,883

(22) Filed: Apr. 23, 2025

(30) Foreign Application Priority Data
Jul. 12, 2024 (KR) 10-2024-0092687

(51) Int. Cl. F26B 21/00; H01M 4/04

(52) U.S. Cl. CPC F26B 21/50; F26B 21/001; H01M 4/0404; H01M 4/0435

(57) ABSTRACT

An apparatus for manufacturing an electrode plate of a secondary battery, the apparatus including a coating unit configured to coat a substrate with an electrode material, a roll pressing unit configured to press an electrode plate coated with the electrode material, and a drying unit configured to dry one of the electrode plate coated with the electrode material and a rolled electrode plate, wherein the drying unit includes a perforated plate with first air holes that are uniformly spaced and uniformly sized for applying heat air to the one of the electrode plate coated with the electrode material and the rolled electrode plate, and a screen with second air holes that are non-uniform, the screen configured to compensate for uneven airflow.

### CROSS-REFERENCE TO RELATED APPLICATION

The present application claims priority to and the benefit of Korean Patent Application No. 10-2024-0092687, filed on July 12, 2024, in the Korean Intellectual Property Office, the entire disclosure of which is incorporated herein by reference.

### BACKGROUND

### FIELD

Embodiments relate to an apparatus and method for manufacturing an electrode plate of a secondary battery, and a device for drying an electrode plate of a secondary battery.

### DESCRIPTION OF THE RELATED ART

Different from primary batteries that cannot be charged, secondary batteries can be recharged. Typically, a secondary battery includes an electrode assembly formed of positive/negative electrode plates and a separator. The positive/negative electrode plates may be manufactured through processes such as rolling, drying, slitting, and notching after a process of coating a substrate with an active material. An electrode assembly is manufactured with the positive/negative electrode plates manufactured in this manner and the separator interposed therebetween using a winding method or a stacking method.

A process of manufacturing a secondary battery may include a coating process of coating one or both surfaces of an electrode substrate with an active material mixture and a roll pressing process of pressing and stretching an electrode plate coated with the mixture through the coating process using a roller to make the electrode plate thin and flat, thereby improving density and enabling the smooth movement of lithium ions to increase the output and performance of the battery.

A drying unit may be used to dry the electrode plate undergoing the coating process and/or rolling process. The drying unit dries a solvent component from the electrode plate by spraying and applying heat air to the coated electrode plate.

The above information disclosed in this Background section is for enhancement of understanding of the background of the present disclosure, and therefore, it may contain information that does not constitute related (or prior) art.

### SUMMARY

Embodiments include an apparatus for manufacturing an electrode plate of a secondary battery, the apparatus including a coating unit configured to coat a substrate with an electrode material, a roll pressing unit configured to press an electrode plate coated with the electrode material, and a drying unit configured to dry one of the electrode plate coated with the electrode material and a rolled electrode plate, wherein the drying unit includes a perforated plate with first air holes that are uniformly spaced and uniformly sized for applying heat air to the one of the electrode plate coated with the electrode material and the rolled electrode plate, and a screen with second air holes that are non-uniform, the screen configured to compensate for uneven airflow.

The second air holes may be configured to provide an airflow amount that decreases toward a position corresponding to an edge of the electrode plate.

Diameters of the second air holes may be smaller toward an edge of the electrode plate.

A size of the second air holes may decrease and a number of the second air holes may increase toward a position corresponding to an edge of the electrode plate.

The screen may include a first screen and a second screen, air holes of the first screen may be configured to provide an airflow amount that decreases toward a position corresponding to a first edge of the electrode plate, and air holes of the second screen may be configured to provide an airflow amount that decreases toward a position corresponding to a second edge of the electrode plate.

The first screen and the second screen may be movable in a transverse direction of the electrode plate.

The screen may be positioned between the drying unit and the perforated plate.

The screen may be positioned between the perforated plate and the electrode plate.

Embodiments include a method of manufacturing an electrode plate of a secondary battery, the method including performing one of coating an electrode plate with an electrode material, resulting in a coated electrode plate, and roll-pressing an electrode plate coated with an electrode material, resulting in a rolled electrode plate, and drying the one of the coated electrode plate and the rolled electrode plate by applying heat air thereto, wherein the drying uniformly applies the heat air to the electrode plate through a perforated plate with first air holes that are uniformly spaced and uniformly sized for applying the heat air to the electrode plate, and a screen with second air holes that are non-uniform, the screen configured to compensate for uneven airflow.

The second air holes may be configured to provide an airflow amount that decreases toward a position corresponding to an edge of the electrode plate.

The screen may include a first screen with air holes that are non-uniform and a second screen with air holes that are uniform, and the drying may include moving the first screen so that an airflow amount decreases as the first screen moves toward a position corresponding to a first edge of the electrode plate, and moving the second screen so that an airflow amount decreases as the second screen moves toward a position corresponding to a second edge of the electrode plate.

Embodiments include a device for drying an electrode plate of a secondary battery, which may include a perforated plate with first air holes that are uniform and configured to apply heat air to an electrode plate, and a screen with second air holes that are non-uniform to compensate for uneven airflow.

The second air holes may be configured to apply an airflow amount that decreases toward a position corresponding to an edge of the electrode plate.

Diameters of the second air holes may be smaller toward an edge of the of the electrode plate.

A size of the second air holes may decrease and a number of the second air holes may increase toward a position corresponding to an edge of the electrode plate.

The screen may include a first screen and a second screen, air holes of the first screen may be configured to provide an airflow amount that decreases toward a position corresponding to a first edge of the electrode plate, and air holes of the second screen may be configured to provide an airflow amount that decreases toward a position corresponding to a second edge of the electrode plate.

The screen may be positioned between the perforated plate and the drying unit.

The screen may be positioned between the perforated plate and the electrode plate.

The first screen and the second screen may be movable in a transverse direction of the electrode plate.

Features and aspects of the present disclosure is not limited to the above, and other features and aspects not specifically mentioned herein, will be clearly understood by those of ordinary skill in the art from the description of the present disclosure below.

### BRIEF DESCRIPTION OF THE DRAWINGS

Features will become apparent to those of ordinary skill in the art by describing in detail exemplary embodiments with reference to the attached drawings, in which:

FIG. 1 is a schematic diagram illustrating an electrode assembly of a secondary battery;

FIG. 2 is a schematic diagram for describing a process of manufacturing an electrode plate of the electrode assembly illustrated in FIG. 1;

FIG. 3 is a schematic diagram illustrating an electrode plate drying unit according to one or more embodiments of the present disclosure when viewed from the side;

FIG. 4 is a perspective view illustrating the electrode plate drying unit of FIG. 3 when viewed from above;

FIG. 5 is a schematic diagram illustrating the drying unit according to the present disclosure;

FIG. 6A is a detailed configuration diagram illustrating the main parts of FIG. 5;

FIG. 6B is a diagram illustrating a perforated plate of FIG. 6A together with first and second screens;

FIG. 7 is a diagram for describing the positions of the first screen and the second screen for uniformly drying an electrode plate with a first form factor;

FIG. 8 is a diagram for describing the positions of the first screen and the second screen for uniformly drying the electrode plate with a second form factor;

FIG. 9 is a diagram illustrating the positions of the first screen and the second screen under a condition that a uniform amount of heat may be applied to the electrode plate using only the perforated plate;

FIG. 10 is a schematic diagram illustrating a pouch-type secondary battery to which an electrode assembly manufactured with a dried electrode plate is applied according to one or more embodiments of the present disclosure;

FIG. 11 is a cross-sectional view illustrating a cylindrical-type secondary battery to which the electrode assembly manufactured with the dried electrode plate is applied according to one or more embodiments of the present disclosure; and

FIG. 12 a cross-sectional view illustrating a prismatic-type secondary battery to which the electrode assembly manufactured with the dried electrode plate is applied according to one or more embodiments of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that if a layer or element is referred to as being “on” another layer or substrate, it can be directly on the other layer or substrate, or intervening layers may also be present. Further, it will be understood that if a layer is referred to as being “under” another layer, it can be directly under, and one or more intervening layers may also be present. In addition, it will also be understood that if a layer is referred to as being “between” two layers, it can be the only layer between the two layers, or one or more intervening layers may also be present. Like reference numerals refer to like elements throughout.

The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her disclosure in the best way.

The embodiments described in this specification and the configurations shown in the drawings are only some of one or more embodiments of the present disclosure and do not represent all of the aspects of the present disclosure. Accordingly, it should be understood that there may be various equivalents and modifications that can replace or modify one or more embodiments described herein at the time of filing this application.

It will be understood that if an element or layer is referred to as being “on,” “connected to,” or “coupled to” another element or layer, it may be directly on, connected, or coupled to the other element or layer or one or more intervening elements or layers may also be present. If an element or layer is referred to as being “directly on,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

In the drawings, dimensions of the various elements, layers, etc. may be exaggerated for clarity of illustration. The same reference numerals designate the same elements. As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. If phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, the applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same.” Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.”

Throughout the specification, if “A and/or B” is stated, it means A, B or A and B, unless otherwise stated. That is, “and/or” includes any or all combinations of a plurality of items enumerated. If “C to D” is stated, it means C or more and D or less, unless otherwise specified.

The terminology used herein is for the purpose of describing embodiments of the present disclosure and is not intended to limit the present disclosure.

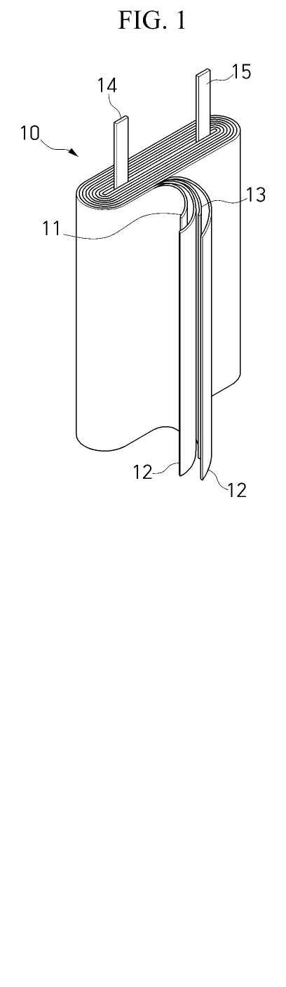

FIG. 1 shows an electrode assembly of a secondary battery.

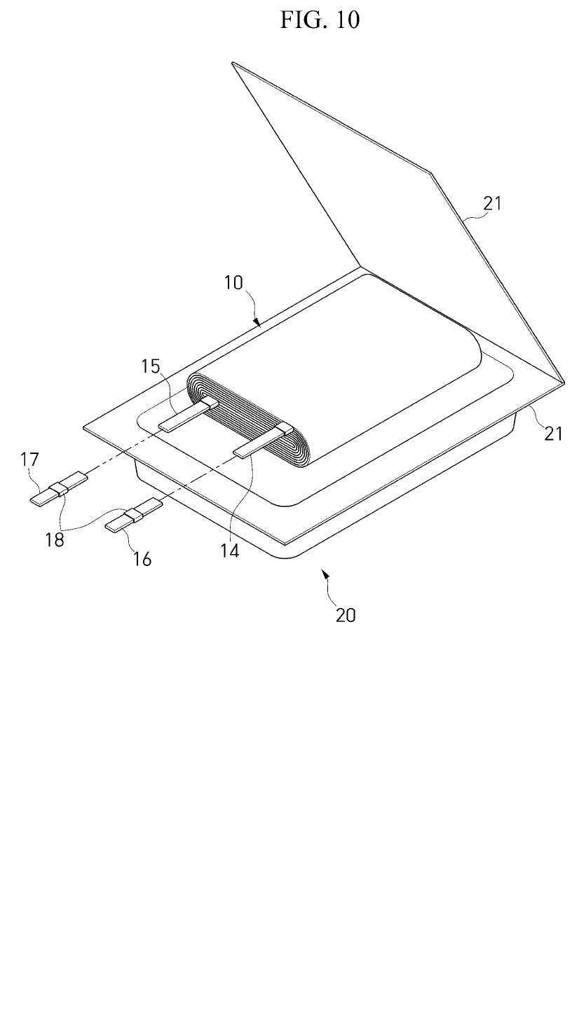

Referring to FIG. 1, an electrode assembly 10 may be formed by winding or stacking a stack of a first electrode plate 11, a separator 12, and a second electrode plate 13, which are formed as thin plates or films. Where the electrode assembly 10 is a wound stack, a winding axis may be parallel to the longitudinal direction (e.g., the y direction in the orientation shown) of a case (e.g., see FIG. 10). In one or more other embodiments, the electrode assembly 10 may be a stack type rather than a winding type, and the shape of the electrode assembly 10 is not limited in the present disclosure. In addition, the electrode assembly 10 may be a Z-stack electrode assembly in which a positive electrode plate and a negative electrode plate are inserted onto both sides of a separator, which is then bent into a Z-stack. In addition, one or more electrode assemblies may be stacked such that long sides of the electrode assemblies are adjacent to each other and accommodated in the case, and the number of electrode assemblies in the case is not limited in the present disclosure. The first electrode plate 11 of the electrode assembly may act as a negative electrode, and the second electrode plate 13 may act as a positive electrode. Of course, the reverse is also possible.

The first electrode plate 11 may be formed by applying a first electrode active material, such as graphite or carbon, on a first electrode current collector formed of a metal foil, such as copper, a copper alloy, nickel, or a nickel alloy. A first electrode tab 14 (e.g., a first uncoated portion), which is a region where the first electrode active material is not applied, may be connected to a first external terminal (not shown). In some embodiments, when the first electrode plate 11 is manufactured, the first electrode tab 14 may be formed by being cut in advance to protrude to one side of the electrode assembly 10, or the first electrode tab 14 may protrude to one side of the electrode assembly 10 more than (e.g., farther than or beyond) the separator 12 without being separately cut.

The second electrode plate 13 may be formed by applying a second electrode active material, such as a transition metal oxide, on a second electrode current collector formed of a metal foil, such as aluminum or an aluminum alloy. The second electrode plate 13 may include a second electrode tab 15 (e.g., a second uncoated portion) that is a region to which the second electrode active material is not applied. The second electrode tab 15 may be connected to a second external terminal (not shown). In some embodiments, the second electrode tab 15 may be formed by being cut in advance to protrude to the other side (e.g., the opposite side) of the electrode assembly 10 when the second electrode plate 13 is manufactured, or the second electrode plate 13 may protrude to the other side of the electrode assembly more than (e.g., farther than or beyond) the separator 12 without being separately cut.

The separator 12 prevents a short circuit between the first electrode plate 11 and the second electrode plate 13 while allowing the movement of lithium ions therebetween. The separator 12 may be made of, for example, a polyethylene film, a polypropylene film, a polyethylene-polypropylene film, or the like.

In some embodiments, the electrode assembly 10 may be accommodated in the case (e.g., see FIG. 10) along with an electrolyte. In the case of a pouch-type secondary battery, an electrode assembly 10 may be accommodated in a pouch made of flexible material in the form illustrated in FIG. 10. In the case of a cylindrical or prismatic secondary battery, an electrode assembly 10 may be accommodated in a cylindrical or prismatic metal case.

Hereinafter, a material that can be used for the electrode plate of the electrode assembly according to the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material may range from about 90 wt% to about 99.5 wt% based on 100 wt% of the positive electrode active material layer, and the content of the binder and the conductive material may range from about 0.5 wt% to about 5 wt%, respectively, based on 100 wt% of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of doping and dedoping lithium, or a transition metal oxide.

The material capable of reversibly intercalating/deintercalating lithium ions may include a carbon-based negative electrode active material, for example, crystalline carbon, amorphous carbon, or a combination thereof. Examples of the crystalline carbon may include graphite, such as natural graphite or artificial graphite, and examples of the amorphous carbon may include soft carbon, hard carbon, mesophase pitch carbide, calcined coke, and the like.

A Si-based negative electrode active material or an Sn-based negative electrode active material may be used as the material capable of doping and dedoping lithium. The Si-based negative electrode active material may be silicon, a silicon-carbon composite, SiOₓ (0 < x < 2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and a silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt% based on 100 wt% of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, a conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of a cyclic carbonate and a chain carbonate may be used.

Depending on the type of lithium secondary battery, a separator may be present between the positive electrode and the negative electrode. As the separator, polyethylene, polypropylene, polyvinylidene fluoride, or a multilayered film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃,SrTiO₃, BaTiO₃, Mg(OH)₂, boehmite, and combinations thereof but is not limited thereto.

The organic material and the inorganic material may be mixed in one coating layer or may be in a laminated form of a coating layer containing an organic material and a coating layer containing an inorganic material.

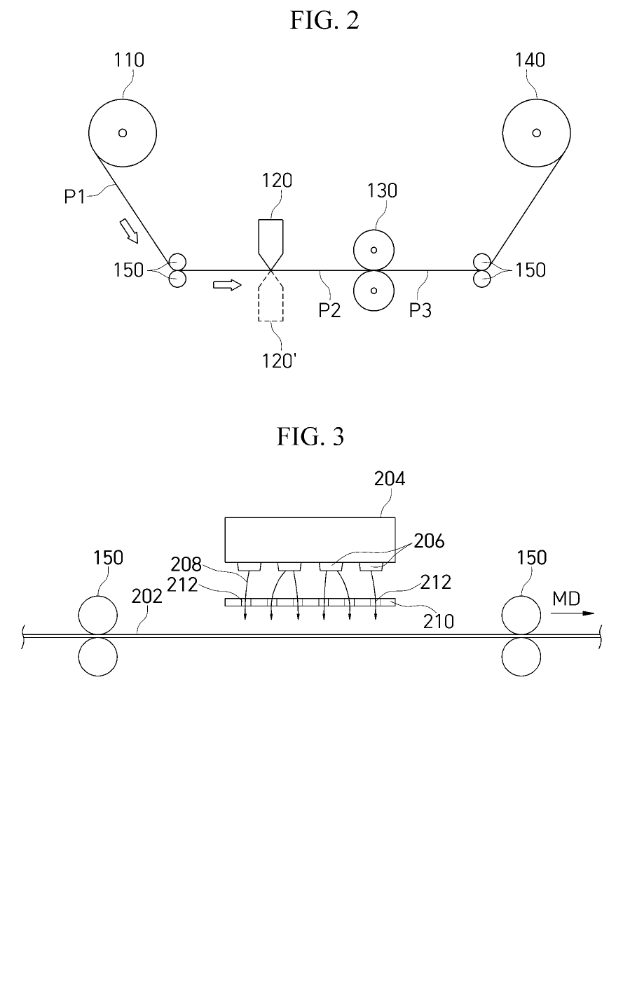

FIG. 2 is a schematic diagram for schematically explaining a process for manufacturing the electrode plate (i.e., the first electrode plate 11 or the second electrode plate 13) of the electrode assembly 10 illustrated in FIG. 1.

A supply roll 110 is a roll on which a substrate P1 for an electrode plate is wound. When an apparatus for manufacturing electrode plates according to the present disclosure is used to manufacture a positive electrode plate, the substrate P1 may be, for example, a metal foil containing aluminum (Al). Alternatively, when the apparatus for manufacturing electrode plates according to the present disclosure is used to manufacture a negative electrode plate, the substrate P1 may be a metal foil containing copper (Cu) or nickel (Ni).

A transfer roller 150 may be an idle roller that guides the substrate P1 unwounded from the supply roll 110, or a drive roller that applies a pulling force to allow the substrate P1 to be unwound from the supply roll 110. FIG. 2 illustrates a total of four transfer rollers 150 as an example, but the number and positions of transfer rollers may be changed as needed.

A coating unit 120 forms a coating layer by coating the substrate P1 with an electrode material slurry that is previously prepared. It is possible to simultaneously coat both surfaces, namely the upper and lower surfaces, of the substrate P1 by adding a second coating unit 120’ having the same configuration as the coating unit 120 illustrated in FIG. 2 below the substrate P1.

The electrode materials to be coated may have a slurry state in which an active material, a conductive material, a binder, other additives, and a solvent have been mixed, or may have a powder state in which an active material, a conductive material, a binder, and other additives have been mixed without a solvent. In this case, the active material may be a substance that activates an electrode reaction of a secondary battery at the positive electrode and negative electrode. That is, the active material may refer to an active material that generates electrical energy through a chemical reaction. The conductive material may be an additive substance for increasing the conductivity of the active material. The binder functions to fix or bond the active material to the substrate. Other additives are substances that are added for the purpose of reducing charging speed, improving energy density, and stabilizing the battery. The solvent may be a liquid that is needed to form a slurry state of an active material, a conductive material, and other additives. Among the processes of manufacturing electrode materials, a solvent may be used in a wet process, but may not be used in a dry process.

A roll pressing unit 130, i.e., a rolling unit, uses a roll pressing roller to press an electrode plate P2 coated with the slurry (mixture) by the coating unit 120 in order to produce a high-capacity and high-density secondary battery.

A winding roll 140 is a roll that winds and accommodates an electrode plate P3 coated and rolled by the coating unit 120 and the roll pressing unit 130.

Meanwhile, although not illustrated in FIG. 2, a drying unit may be added between the coating unit 120 and the winding roll 140 to dry or solidify the electrode plate P2 coated with the slurry. The drying unit may include a heat source. In addition, the drying unit may be physically separated from or functionally integrated into the roll pressing unit 130. For example, when the roll pressing unit 130 is configured in the form of a roller, the roller may be equipped with a heat source to heat and simultaneously roll the coating layer, thereby allowing the roll pressing unit 130 to also function as a drying unit.

When the electrode plate is manufactured, a process of drying a liquid component contained in the slurry may be required. In the drying process, a drying unit for drying the electrode plate by spraying heat air by utilizing a drying duct may be used. The drying process may be performed after the electrode plate coating process and/or roll pressing process.

FIG. 3 is a schematic diagram illustrating an electrode plate drying unit (or a drying furnace) according to one or more embodiments of the present disclosure when viewed from the side. An electrode plate drying unit 204 may include a nozzle 206 for spraying heat air 208 and a perforated plate 210 in which a plurality of air holes 212 are formed to distribute the sprayed heat air and uniformly apply the heat air to the electrode plate.

In FIG. 3, MD, machine direction, stands for a traveling direction of the electrode plate.

In this way, the heat air 208 sprayed from the drying unit 204 may be distributed over a wide area through the plurality of air holes 212 of the perforated plate 210 to dry a solvent component contained in the slurry on the electrode plate coated with the slurry.

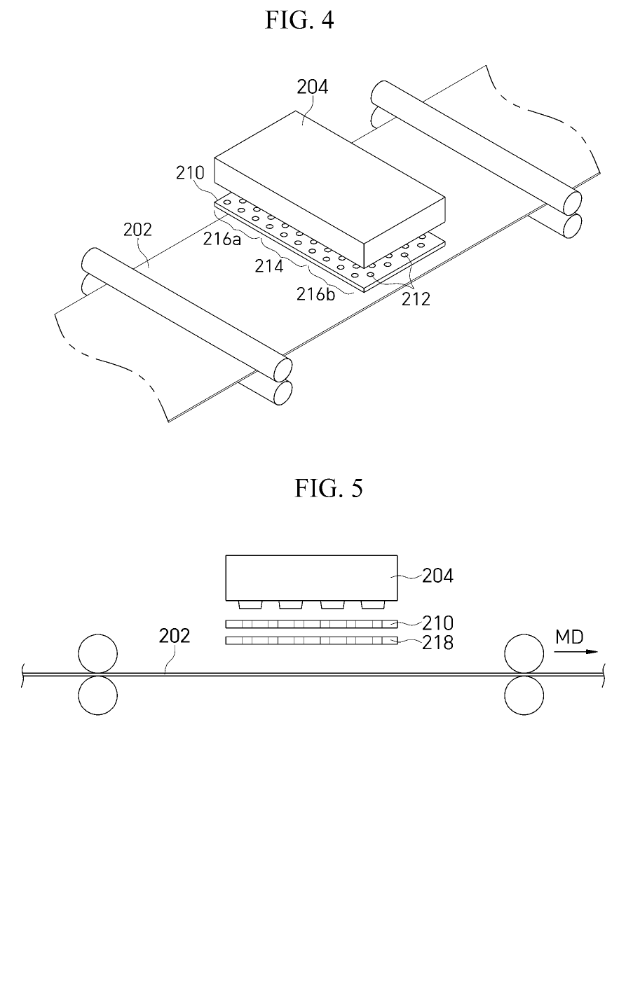

FIG. 4 is a perspective view illustrating the electrode plate drying unit 204 of FIG. 3 when viewed from above. As shown in FIG. 4, the air holes 212 of the perforated plate 210 may be disposed with a uniform airflow amount to uniformly distribute the heat air 208 to the electrode plate (e.g., the air holes 212 may be uniformly sized and uniformly spaced). However, in reality, the heat air 208 may tend to be concentrated at both edges 216a and 216b in a larger amount than at a center 214 of the electrode plate so that a phenomenon in which the edges are over-dried compared to the center may occur.

FIG. 5 depicts a drying unit 204 having the structure of various embodiments. In the drying unit 204, in addition to the perforated plate 210 in which the air holes with a uniform airflow amount are formed, a screen 218 in which air holes with a non-uniform airflow amount are formed may be installed separately from the perforated plate 210.

To address the above, the air holes with a non-uniform airflow amount, which are formed in the screen 218 at the edges of the electrode plate, may have an airflow amount that is less than that of the air holes at the center of the electrode plate. In this way, an amount of heat may be supplied uniformly to the center and edges of the electrode plate. However, a distribution of the air holes disposed in the screen 218 in a predetermined form with a non-uniform airflow amount may be changed when a form factor of the electrode plate changes, and a plurality of screens 218 may be manufactured and replaced according to the form factor of the electrode plate.

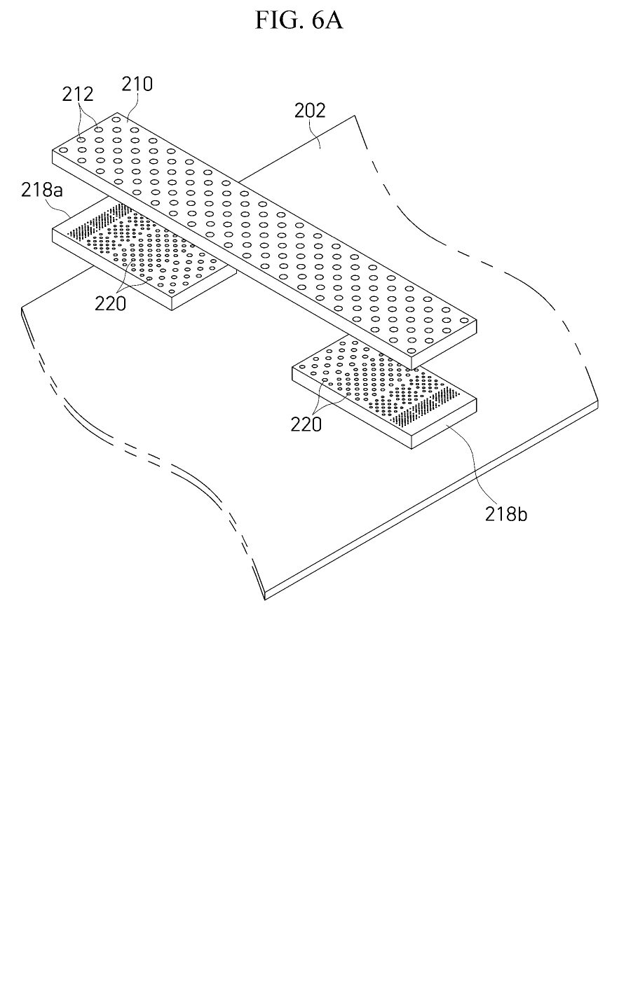

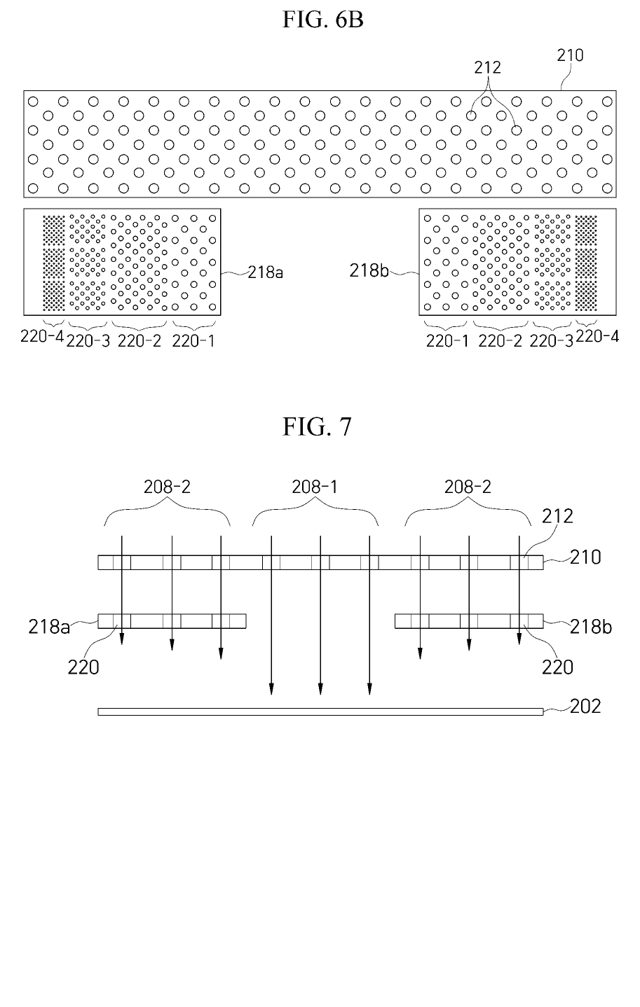

FIG. 6A is a configuration diagram illustrating a screen according to one or more embodiments. With respect to the screen(s) herein, holes of varying sizes, varying shapes and/or varying intervals, as well as varying placement may be used, which contrasts with the uniform air holes of perforated plate 210.

A first screen 218a and a second screen 218b, which have air holes 220 disposed with a non-uniform airflow amount, may be symmetrically disposed below both end portions of the perforated plate 210 having air holes 212 disposed with a uniform airflow amount. The air holes 220 of the first and second screens 218a and 218b may have a smaller airflow amount toward the edge of the electrode plate. A low airflow amount may be that a diameter of the air hole is small or a density thereof is low, but the present disclosure is not limited to the diameter and density parameters.

FIG. 6A shows an embodiment in which the first and second screens 218a and 218b are positioned between the perforated plate 210 and the electrode plate 202, but the present disclosure is not limited thereto. In other embodiments, the first and second screens 218a and 218b may be positioned between the perforated plate 210 and the drying unit 204.

In this way, one set of the first and second screens 218a and 218b may be installed above or below the perforated plate 210 to allow heat air to pass through the air holes 220 with a non-uniform airflow amount so that uniform drying can be achieved over the entire surface of the electrode plate. In addition, even when the form factor of the electrode plate changes, uniform drying can be achieved by moving the first and second screens 218a and 218b to left and right (i.e., in a traverse direction (TD) of the electrode plate) without replacing the screen 218.

Hereinafter, the “arrangement with a uniform airflow amount” and the “arrangement with a non-uniform airflow amount” of the air holes will be simply referred to as a “uniform arrangement” and a “non-uniform arrangement.”

FIG. 6B is a diagram illustrating the perforated plate 210 of FIG. 6A together with the first and second screens 218a and 218b.

The air holes 212 of the perforated plate 210 may be uniformly disposed at the center and edge positions of the electrode plate. The first screen 218a and the second screen 218b may have air holes 220-2, 220-3, and 220-4 formed such that an airflow amount of the air holes 220-1 located over a certain distance from the center of the electrode plate toward the edge thereof gradually decreases toward the edge.

FIG. 7 is a diagram for describing the positions of the first screen 218a and the second screen 218b for uniformly drying an electrode plate 202 with a first form factor.

A left end of the first screen 218a and a right end of the second screen 218b may substantially correspond to a left end and a right end of the perforated plate 210, respectively.

At these positions, heat air 208-1 applied to a center of the electrode plate 202 may be differentiated from heat air 208-2 applied to edges thereof. Specifically, the heat air 208-1 may supplied to the center of the electrode plate 202 through the perforated plate 210, and as the heat air passes through non-uniform air holes 220 of the first screen 218a at the edge shown on the left, an airflow amount may gradually decrease as the heat air 208-2 moves to a left edge of the electrode plate 202 (left 208-2). Similarly, at the edge shown on the right, an airflow amount may gradually decrease as the heat air passes through non-uniform air holes 220 of the second screen 218b and moves to a right edge of the electrode plate 202 (right 208-2).

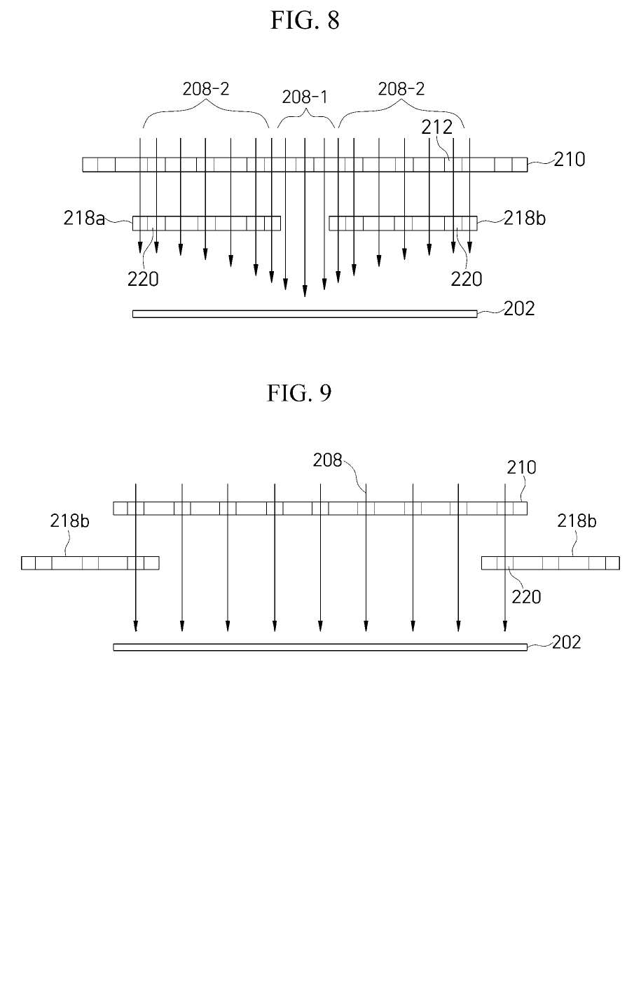

FIG. 8 is a diagram for describing the positions of the first screen 218a and the second screen 218b for uniformly drying the electrode plate 202 with a second form factor.

Since a width of the electrode plate 202 is small, a right end of the first screen 218a and a left end of the second screen 218b may be positioned close to the center of the perforated plate 210.

At these positions, a range of the heat air 208-1 applied to the center of the electrode plate 202 through the perforated plate 210 may decrease, and a range of the heat air 208-2 applied to the electrode plate 202 after passing through the first and second screens 218a and 218b may occupy a large portion. Generally, similar to the case of FIG. 7, the airflow amount of the heat air 208-2 applied to the edges on both sides of the electrode plate 202 may gradually decrease compared to the airflow amount of the heat air 208-1 applied to the center of the electrode plate 202.

FIG. 9 is a diagram illustrating the positions of the first screen 218a and the second screen 218b under a condition that a uniform amount of heat may be applied to the electrode plate 202 using only the perforated plate 210 (e.g., using mostly just the perforated plate 210).

The first screen 218a and the second screen 218b may be positioned outside the left and right ends of the perforated plate 210, respectively, so that the right end of the first screen 218a may be positioned close to the left end of the perforated plate 210, and the left end of the second screen 218b may be positioned close to the right end of the perforated plate 210. Most of the heat air may be uniformly applied to the electrode plate 202 through the perforated plate 210.

A method of manufacturing an electrode plate of a secondary battery according to some embodiments of the present disclosure may be described.

As shown in FIG. 2, a substrate may be coated with an electrode material, and an electrode plate coated with the electrode material may be rolled. Drying may be performed by applying heat air to the electrode plate coated with the electrode material or the rolled electrode plate.

As described above, the drying of the electrode plate may be performed using the perforated plate in which air holes with a uniform airflow amount are formed to distribute and apply the heat air to the electrode plate and the screen in which air holes with a non-uniform airflow amount are formed.

The air holes of the screen may be formed such that an airflow amount decreases toward a position corresponding to an edge of the electrode plate.

In some embodiments, the screen may include a first screen in which air holes with a non-uniform airflow amount are disposed and a second screen in which air holes with a non-uniform airflow amount are disposed. In this case, drying may be performed by moving the first screen so that the airflow amount decreases toward a position corresponding to a first edge of the electrode plate and moving the second screen so that the airflow amount decreases toward a position corresponding to a second edge of the electrode plate.

FIG. 10 is a schematic diagram illustrating a pouch-type secondary battery to which the electrode assembly manufactured with a dried electrode plate is applied using the drying device and method according to the above-described embodiments of the present disclosure.

The pouch-type secondary battery shown in FIG. 10 includes an electrode assembly 10 and a pouch 20 that accommodates the electrode assembly 10.

The electrode assembly 10 is the same as that illustrated in FIG. 1. The first electrode tab 14 and the second electrode tab 15 of the electrode assembly 10 may be electrically connected to respective external first and second terminal leads 16 and 17 by welding. Each of the first terminal lead 16 and the second terminal lead 17 may be attached with a tab film 18 for insulation from the pouch 20.

The pouch 20 may be sealed by bringing sealing parts 21 at the edges thereof into contact with each other while accommodating the electrode assembly 10 therein, in which case the sealing may be achieved with the tab film 18 interposed between the sealing parts 21. The sealing parts 21 of the pouch 20 may each be made of a heat sealing material that generally has weak adhesion to metal. Thus, it may be fused to the pouch 20 by interposing the thin tab film 18 between the sealing parts 21.

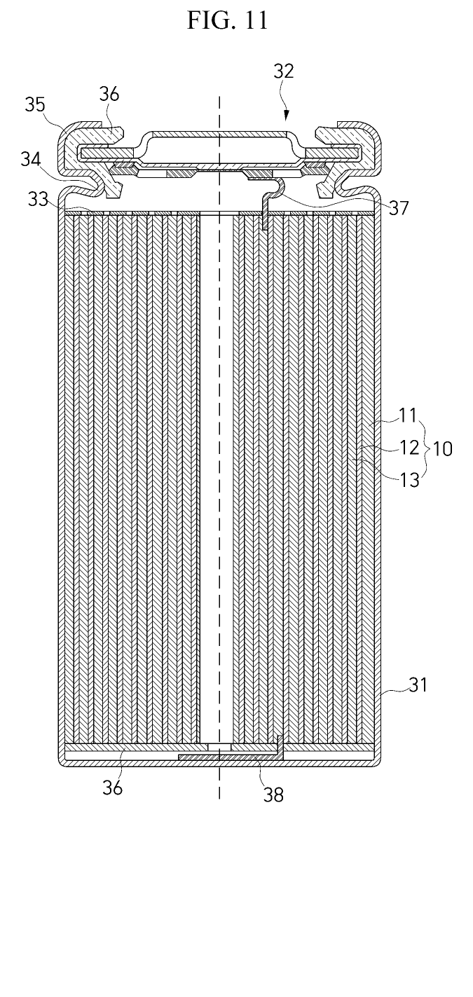

FIG. 11 is a cross-sectional view illustrating a cylindrical-type secondary battery to which the electrode assembly manufactured with the dried electrode plate is applied using the drying device and method according to the above-described embodiments of the present disclosure.

As shown in FIG. 11, the secondary battery may include an electrode assembly 10, a case 31 accommodating the electrode assembly 10 and an electrolyte therein, a cap assembly 32 coupled to an opening of the case 31 to seal the case 31, and an insulating plate 33 positioned between the electrode assembly 10 and the cap assembly 32 inside the case 31.

The case 31 accommodates the electrode assembly 10 and the electrolyte, and, together with the cap assembly 32, forms the external appearance of the secondary battery. The case 31 may have a substantially cylindrical body portion and a bottom portion connected to one side (e.g., to one end) of the body portion. A beading part 34 (e.g., a bead) deformed inwardly may be formed in the body portion, and a crimping part 35 (e.g., a crimp) bent inwardly may be formed at an open end of the body portion.

The beading part 34 can reduce or prevent the movement of the electrode assembly 10 inside the case 31 and can facilitate the seating of the gasket and the cap assembly 32. The crimping part 35 may firmly fix the cap assembly 32 by pressing the edge of the case 31 against the gasket 36. The case 31 may be formed of iron plated with nickel, for example.

The cap assembly 32 may be fixed to the inside of the crimping part 35 by a gasket 36 to seal the case 31. A first lead tab 37 drawn out from the electrode assembly 10 may be connected to the cap assembly 32, and a second lead tab 38 drawn out from the electrode assembly 10 may be electrically connected to the bottom of the case 31.

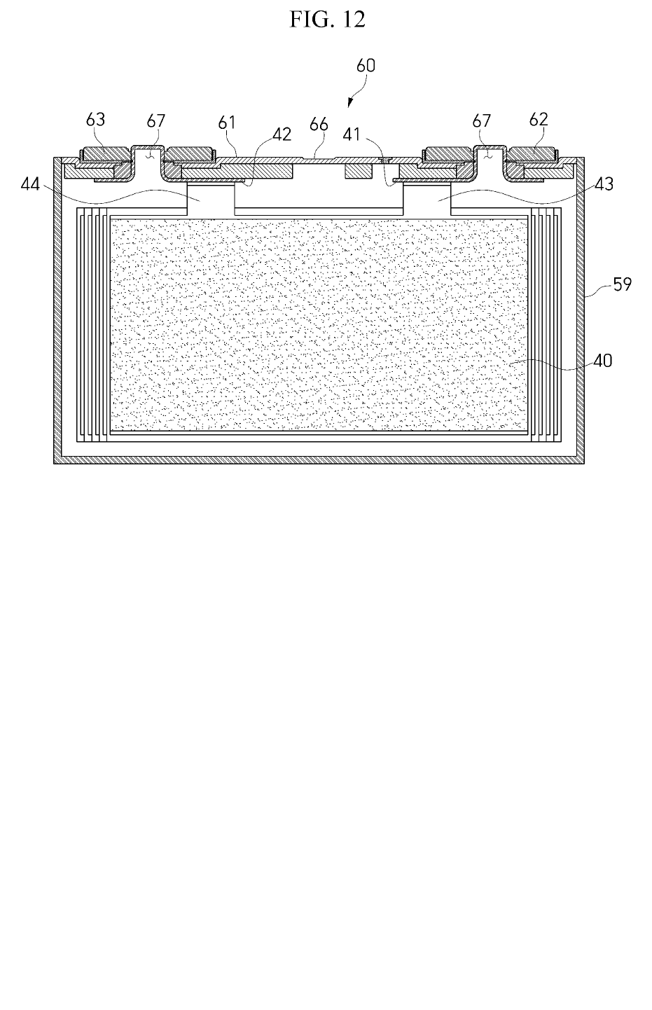

FIG. 12 is a cross-sectional view illustrating a prismatic-type secondary battery to which the electrode assembly manufactured with the dried electrode plate is applied using the drying device and method according to the above-described embodiments of the present disclosure.

As shown in FIG. 12, the prismatic secondary battery may include an electrode assembly 40, a first current collector 41, a first terminal 62, a second current collector 42, a second terminal 63, a case 51, and a cap assembly 60.

The electrode assembly 40 may be formed by winding or stacking a stack of a first electrode plate, a separator, and a second electrode plate, which are formed as thin plates or films. When the electrode assembly 40 is a wound stack, a winding axis may be parallel to the longitudinal direction (e.g., the y direction) of the case 51. In other embodiments, the electrode assembly 40 may be a stack type rather than a winding type, and the shape of the electrode assembly 40 is not limited in the present disclosure. In addition, the electrode assembly 40 may be a Z-stack electrode assembly in which a positive electrode plate and a negative electrode plate are inserted onto both sides of a separator, which is then bent into a Z-stack. In addition, one or more electrode assemblies may be stacked such that long sides of the electrode assemblies are adjacent to each other and accommodated in the case, and the number of electrode assemblies in the case is not limited in the present disclosure. The first electrode plate of the electrode assembly may act as a negative electrode, and the second electrode plate may act as a positive electrode. Of course, the reverse is also possible.

In the electrode assembly 40, the first current collector 41 and the second current collector 42 may be welded and connected to the first electrode tab 43 extending from the first electrode plate and the second electrode tab 44 extending from the second electrode plate, respectively. As mentioned above, in some embodiments in which the first electrode tab 43 and the second electrode tab 44 are located at the top of the electrode assembly 40, the first and second current collectors are located above the electrode assembly 40.

As illustrated in FIG. 12, the first current collector 41 and the second current collector 42 are connected to the first terminal 62 and the second terminal 63 through connection members 67, respectively. In some embodiments, the connection members 67 may each have an outer peripheral surface that is threaded, and may be fastened to the first terminal 62 and the second terminal 63 by screw coupling. However, the present disclosure is not limited thereto. For example, the connection members 67 may also be coupled to the first terminal 62 and the second terminal 63 by riveting or welding.

According to the present disclosure, uniform drying can be achieved over the entire area of the electrode plate, and there is no need to separately manufacture a perforated plate for each form factor of the electrode plate. Therefore, the effects of improving quality of the electrode plate, enhancing safety, and reducing costs can be obtained. In addition, since there are no problems such as a decrease in temperature of a drying furnace and an additional replacement time due to the replacement of a perforated plate, an effect of increased productivity can be further obtained.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated.Accordingly, it will be understood by those of ordinary skill in the art that various changes in form and details may be made without departing from the spirit and scope of the present invention as set forth in the following claims.

What is claimed is:

1. An apparatus for manufacturing an electrode plate of a secondary battery, the apparatus comprising:
a coating unit configured to coat a substrate with an electrode material;
a roll pressing unit configured to press an electrode plate coated with the electrode material; and
a drying unit configured to dry one of the electrode plate coated with the electrode material and a rolled electrode plate,
wherein the drying unit includes:
a perforated plate with first air holes that are uniformly spaced and uniformly sized for applying heat air to the one of the electrode plate coated with the electrode material and the rolled electrode plate; and
a screen with second air holes that are non-uniform, the screen configured to compensate for uneven airflow.

2. The apparatus as claimed in claim 1, wherein the second air holes are configured to provide an airflow amount that decreases toward a position corresponding to an edge of the electrode plate.

3. The apparatus as claimed in claim 1, wherein diameters of the second air holes are smaller toward an edge of the electrode plate.

4. The apparatus as claimed in claim 1, wherein a size of the second air holes decreases and a number of the second air holes increases toward a position corresponding to an edge of the electrode plate.

5. The apparatus as claimed in claim 1, wherein:
the screen comprises a first screen and a second screen;
air holes of the first screen are configured to provide an airflow amount that decreases toward a position corresponding to a first edge of the electrode plate; and
air holes of the second screen are configured to provide an airflow amount that decreases toward a position corresponding to a second edge of the electrode plate.

6. The apparatus as claimed in claim 5, wherein the first screen and the second screen are movable in a transverse direction of the electrode plate.

7. The apparatus as claimed in claim 1, wherein the screen is positioned between the drying unit and the perforated plate.

8. The apparatus as claimed in claim 1, wherein the screen is positioned between the perforated plate and the electrode plate.

9. A method of manufacturing an electrode plate of a secondary battery, the method comprising:
performing one of coating an electrode plate with an electrode material, resulting in a coated electrode plate, and roll-pressing an electrode plate coated with an electrode material, resulting in a rolled electrode plate; and
drying the one of the coated electrode plate and the rolled electrode plate by applying heat air thereto,
wherein the drying uniformly applies the heat air to the electrode plate through a perforated plate with first air holes that are uniformly spaced and uniformly sized for applying the heat air to the electrode plate, and a screen with second air holes that are non-uniform, the screen configured to compensate for uneven airflow.

10. The method as claimed in claim 9, wherein the second air holes are configured to provide an airflow amount that decreases toward a position corresponding to an edge of the electrode plate.

11. The method as claimed in claim 9, wherein:
the screen comprises a first screen with air holes that are non-uniform and a second screen with air holes that are uniform; and
the drying includes:
moving the first screen so that an airflow amount decreases as the first screen moves toward a position corresponding to a first edge of the electrode plate; and
moving the second screen so that an airflow amount decreases as the second screen moves toward a position corresponding to a second edge of the electrode plate.

12. A device for drying an electrode plate of a secondary battery, the device comprising:
a perforated plate with first air holes that are uniform configured to apply heat air to an electrode plate; and
a screen with second air holes that are non-uniform to compensate for uneven airflow.

13. The device as claimed in claim 12, wherein the second air holes are configured to apply an airflow amount that decreases toward a position corresponding to an edge of the electrode plate.

14. The device as claimed in claim 12, wherein diameters of the second air holes are smaller toward an edge of the of the electrode plate.

15. The device as claimed in claim 12, wherein a size of the second air holes decreases and a number of the second air holes increases toward a position corresponding to an edge of the electrode plate.

16. The device as claimed in claim 12, wherein:
the screen comprises a first screen and a second screen;
air holes of the first screen are configured to provide an airflow amount that decreases toward a position corresponding to a first edge of the electrode plate; and
air holes of the second screen are configured to provide an airflow amount that decreases toward a position corresponding to a second edge of the electrode plate.

17. The device as claimed in claim 12, wherein the screen is positioned between the perforated plate and the drying unit.

18. The device as claimed in claim 12, wherein the screen is positioned between the perforated plate and the electrode plate.

19. The device as claimed in claim 16, wherein the first screen and the second screen are movable in a transverse direction of the electrode plate.
